(19) United States
(12) Patent Application Publication
(10) Pub. No.: US 2018/0158015 A1
(43) Pub. Date: Jun. 7, 2018

(54) INVENTORY MANAGEMENT SYSTEM AND INVENTORY MANAGEMENT METHOD

(71) Applicant: INSTITUTE FOR INFORMATION INDUSTRY, TAIPEI (TW)

(72) Inventors: Yen-I OUYANG, New Taipei City (TW); Cheng-Hung WU, Taipei City (TW); Ching-Jung TANG, Taipei City (TW); Yi-Ju TING, Taipei City (TW)

(21) Appl. No.: 15/369,767

(22) Filed: Dec. 5, 2016

(30) Foreign Application Priority Data
Dec. 1, 2016 (TW) 105139740

(51) Int. Cl. G06Q 10/08; G06F 17/30; G06N 99/00; G06N 5/04

(52) U.S. Cl. CPC G06Q 10/087; G06N 5/04; G06N 99/005; G06F 17/30312

(57) ABSTRACT

An inventory management system includes a storage, and a processor. The storage stores a plurality of items, properties of the items, and predetermined classification data. The processor is electrically connected to the storage. The processor is configured to execute steps as follows: (a) classifying each of a plurality of items based on the predetermined classification data, such that each of the items includes a predetermined category, and classifying each of the items based on the predetermined categories and properties of the items, such that each of the items includes a classification category; (b) providing each of the items a prediction module based on the classification categories of the items and the properties of the items; and (c) providing a dynamic inventory-management decision table based on the prediction modules of the items.

### RELATED APPLICATIONS

This application claims priority to TW application No. 105139740, filed Dec. 1, 2016, which is herein incorporated by reference.

### BACKGROUND OF THE INVENTION

### Field of Invention

The present invention relates to a management system and a management method. More particularly, the present invention relates to an inventory management system and inventory management method.

### Description of Related Art

Inventory management plays an important role in business mode. For example, if products sell well, such products may run out of stock due to improper inventory management. The above condition will directly affect sales volume of the products, and profits of the company will decrease. On the contrary, if the products sell poorly, such products may be stocked up due to improper inventory management. Such condition will affect cash flow management of the company, such that the operation of the company will be poor.

Conventional inventory management is to find one proper inventory prediction module for all categories of products, and such inventory prediction module is used to predict inventory of all products and provide inventory suggestions. However, single inventory prediction module is not suitable for all categories of products. Therefore, the inventory prediction may have some error, and profits of the company will be affected.

In view of the foregoing, problems and disadvantages are associated with existing products that require further improvement. However, those skilled in the art have yet to find a solution.

### SUMMARY OF THE INVENTION

The following presents a simplified summary of the disclosure in order to provide a basic understanding to the reader. This summary is not an extensive overview of the disclosure and it does not identify key/critical elements of the present invention or delineate the scope of the present invention.

One aspect of the present disclosure is directed to an inventory management system. The inventory management system comprises a storage and a processor. The storage is configured to store a plurality of items, properties of the items and predetermined classification data. The processor is electrically connected to the storage, and configured to execute steps as follows: (a) classifying each of a plurality of items based on the predetermined classification data, such that each of the items comprises a predetermined category, and classifying each of the items based on the predetermined categories and properties of the items, such that each of the items comprises a classification category; (b) providing each of the items a prediction module based on the classification categories of the items and the properties of the items; and (c) providing a dynamic inventory-management decision table based on the prediction modules of the items.

Another aspect of the present disclosure is directed to an inventory management method. The inventory management method comprises steps as follows: (a) classifying each of a plurality of items based on the predetermined classification data by a processor, such that each of the items comprises a predetermined category, and classifying each of the items based on the predetermined categories and properties of the items by the processor, such that each of the items comprises a classification category; (b) providing each of the items a prediction module based on the classification categories of the items and the properties of the items by the processor; and (c) providing a dynamic inventory-management decision table based on the prediction modules of the items by the processor.

In view of the foregoing, embodiments of the present disclosure provide an inventory management system and an inventory management method, which may provide proper inventory prediction modules based on different categories of products, so as to reduce error of the inventory prediction and enhance profits of companies.

These and other features, aspects, and advantages of the present invention, as well as the technical means and embodiments employed by the present invention, will become better understood with reference to the following description in connection with the accompanying drawings and appended claims.

### BRIEF DESCRIPTION OF THE DRAWINGS

The invention can be more fully understood by reading the following detailed description of the embodiment, with reference made to the accompanying drawings as follows:

FIG. 1 is a schematic diagram of an inventory management system according to embodiments of the present invention; and

FIG. 2 is a flow diagram illustrating the process steps of an inventory management method according to embodiments of the present disclosure.

In accordance with common practice, the various described features/elements are not drawn to scale but instead are drawn to best illustrate specific features/elements relevant to the present invention. Also, wherever possible, like or the same reference numerals are used in the drawings and the description to refer to the same or like parts.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Unless otherwise defined herein, scientific and technical terminologies employed in the present disclosure shall have the meanings that are commonly understood and used by one of ordinary skill in the art. Unless otherwise required by context, it will be understood that singular terms shall include plural forms of the same and plural terms shall include singular forms of the same.

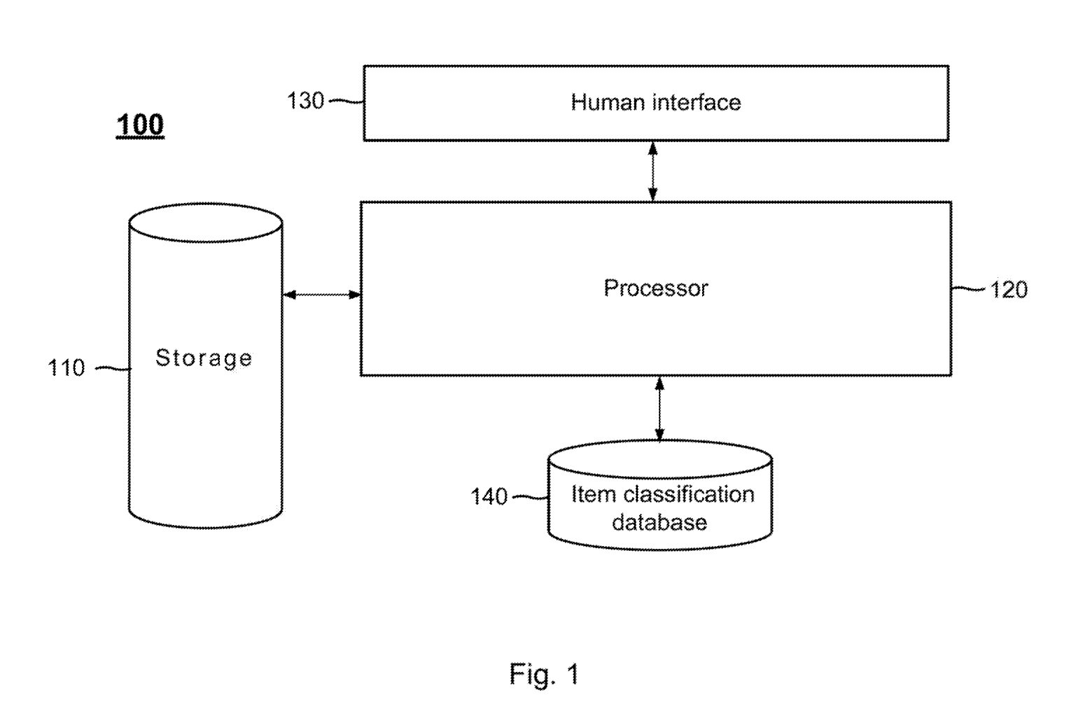

FIG. 1 is a schematic diagram of an inventory management system 100 according to embodiments of the present invention. As shown in the figure, the inventory management system 100 comprises a storage 110, a processor 120, a human interface 130 and an item classification database 140. With respect to connection, the processor 120 is electrically connected to the storage 110, the human interface 130 and the item classification database 140.

With respect to operation, the storage 110 stores a plurality of items, properties of the items and predetermined classification data. In addition, the processor 120 executes steps as follows: (a) classifying each of a plurality of items based on the predetermined classification data, such that each of the items comprises a predetermined category, and classifying each of the items based on the predetermined categories and properties of the items, such that each of the items comprises a classification category. For example, the processor 120 receives predetermined classification data from the storage 110. The predetermined classification data provides a basic for defining categories of the items based on inventory theory, or defines standard items categories based on prediction modules of existing items, which is used to be an initial classification basic for defining the existing items. Besides, the predetermined classification data can also be a basic for defining the categories of the items which is provided by users in advance. In view of the above, the processor 120 can perform preliminary classification to each of the items based on the foregoing initial classification basic (that is the predetermined classification data). It is noted that the items herein can be but not limited to products which have been made or prepared materials for manufacturing the foregoing products.

In addition, for example, the processor 120 can use a machine learning device to classify each of the items based on the predetermined categories of the items and the properties of the items. The machine learning device can be but not limited to Support Vector Machine (SVM). The SVM can further classify the items based on the initial category (that is the predetermined category) of the items for obtaining accurate categories (that is the classification category) which are suitable for each of the items. In one embodiment, if the classification category of one of the items is not suitable for the foregoing item, users can further use the human interface 130 to enter commands for adjusting the classification category of the foregoing item. In another words, the human interface 130 of the present disclosure can be used to interact with users, such that users may use the human interface 130 to adjust the classification category of the item. Besides, the classification category of each of the items can be stored into the item classification database 140 for the following operations.

In one embodiment, the step (a) executed by the processor 120 further comprises: dividing the items into a plurality of training items (i.e., training set) and a plurality of testing items (i.e., testing set); obtaining a first parameter value based on the training items so as to establish a machine learning device SVM, and verifying classification accuracy of the machine learning device SVM by using the testing items; classifying the items by the machine learning device SVM if the classification accuracy of the machine learning device SVM is larger than a predetermining threshold. In another embodiment, the step (a) executed by the processor 120 further comprises: reclassifying the items into the training items and the testing items by the processor 120 if the classification accuracy of the machine learning device SVM is not larger than the predetermining threshold; obtaining a second parameter value based on the training items which are reclassified so as to establish the machine learning device SVM, and verifying classification accuracy of the machine learning device by using the testing items; and classifying the items by the machine learning device SVM if the classification accuracy of the machine learning device SVM is larger than the predetermining threshold. However, if the classification accuracy of the machine learning device SVM is not enough, the step of reclassifying the items to obtain parameters is repeated until the classification accuracy of the machine learning device SVM is enough for executing the classification of the items.

Besides, the processor 120 executes the step (b) as follows: providing each of the items a prediction module based on the classification categories of the items and the properties of the items. For example, after the accurate category (that is the classification category) of each of the items is obtained, the processor 120 can provide each of the items a corresponding prediction module based on the accurate categories of the items and the properties of the items stored in the storage 110. The properties of the items can be but not limited to amount of the items, the selling data of the items, weighting parameters of the items, and so on. Therefore, the processor 120 can determine suitable prediction modules based on accurate categories of the items together with historical selling data, such that the accuracy of the inventory predicted results of the items can be enhanced.

Specifically, the processor 120 obtains the historical selling data of different categories by analyzing the accurate category (that is the classification category) so as to provide the prediction modules which are used by the items, such that the prediction modules may predict predicted demand quantity of the items. In one embodiment, if the prediction module of one of the items is not suitable for the foregoing item, users may use the human interface 130 to enter commands for adjust the prediction module of the foregoing item. In another words, the human interface 130 of the present disclosure can be used to interact with users, such that the accuracy of the prediction module can be enhanced so as to provide precise predicted demand quantity of the items.

Furthermore, the processor 120 executes step (c) as follows: providing a dynamic inventory-management decision table based on the prediction modules of the items. For example, after the prediction module of each of the items is obtained, the processor 120 may provide the dynamic inventory-management decision table based on the prediction module. From the dynamic inventory-management decision table, users may know suggestion inventory-management quantity of each of the items, and users may adjust inventory management based on the suggestion. Specifically, the processor 120 analyzes difference among the predicted demand quantity of the items and actual demand quantity of the items for providing the foregoing dynamic inventory-management decision table so as to decide the ordered quantity of the items. In one embodiment, the human interface 130 of the present disclosure can be used to interact with users so as to make sure the ordered quantity of the items in the dynamic inventory-management decision table. If the ordered quantity of one of the items is not suitable for the foregoing item, users may use the human interface 130 to enter commands for adjust the ordered quantity of one of the foregoing items.

In one embodiment, the processor 120 can generate the predetermined classification data based on categories of the items defined by the inventory theory, and the processor 120 defines the prediction modules of the items corresponding to the predetermined classification data based on properties of the items stored in the storage 110 and the prediction module is then stored in the storage 110. Besides, the processor 120 calculates the demand quantity of the items based on the classification categories of the items and the prediction modules of the items. Furthermore, the processor 120 provides the dynamic inventory-management decision table based on the demand quantity of the items. From the dynamic inventory-management decision table, users may know suggestion inventory-management quantity of each of the items, and users may adjust inventory management based on the suggestion.

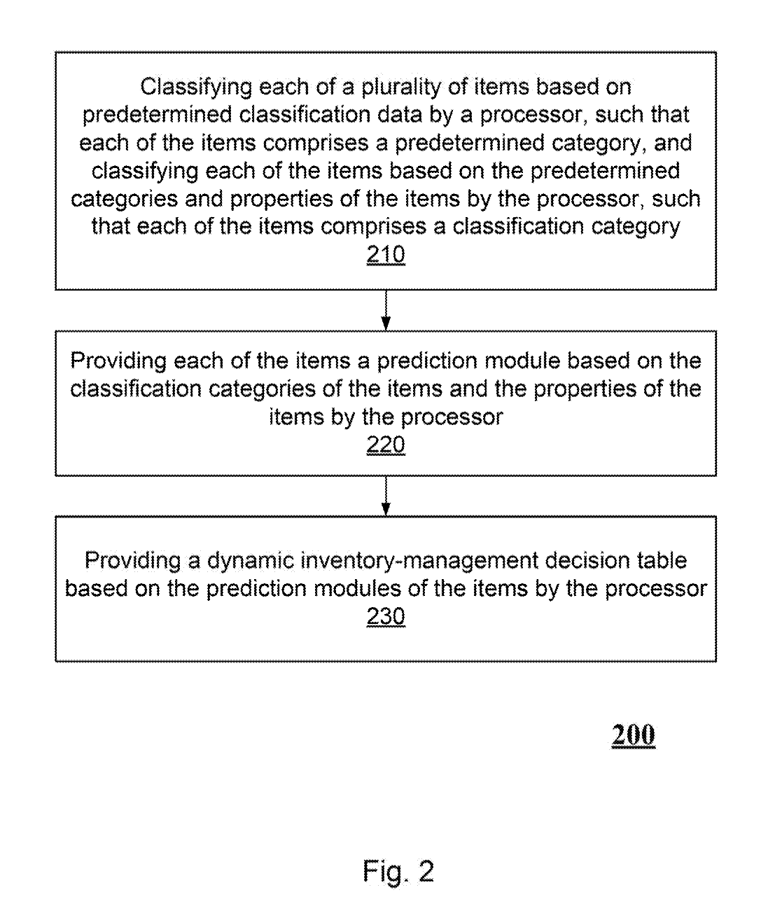

FIG. 2 is a flow diagram illustrating the process steps of an inventory management method 200 according to embodiments of the present disclosure. As shown in the figure, the inventory management method 200 of the present disclosure comprises steps as follows:

step 210: classifying each of a plurality of items based on predetermined classification data by a processor, such that each of the items comprises a predetermined category, and classifying each of the items based on the predetermined categories and properties of the items by the processor, such that each of the items comprises a classification category;

step 220: providing each of the items a prediction module based on the classification categories of the items and the properties of the items by the processor;

step 230: providing a dynamic inventory-management decision table based on the prediction modules of the items by the processor.

For facilitating the understanding the inventory management method 200 of the embodiment of the present invention, reference is now made to FIG. 1 and FIG. 2. In step 210, the inventory management method 200 may use the processor 120 to classify each of a plurality of items in the inventory based on the predetermined classification data, such that each of the items comprises a predetermined category, and classify each of the items based on the predetermined categories and properties of the items, such that each of the items comprises a classification category. In step 220, the inventory management method 200 may use the processor 120 to provide each of the items a prediction module based on the classification categories of the items and the properties of the items. In step 230, the inventory management method 200 may use the processor 120 to provide the dynamic inventory-management decision table based on the prediction modules of the items.

In one embodiment, the step 210 comprises the following flows: receiving predetermined classification data from the storage 110 by the processor 120. The predetermined classification data provides a basic for defining categories of the items based on inventory theory, or defines standard items categories based on prediction modules of existing items, which is used to be an initial classification basic for defining the existing items. Besides, the predetermined classification data can also be a basic for defining the categories of the items which is provided by users in advance. In view of the above, the inventory management method 200 may use the processor 120 to perform preliminary classification to each of the items based on the foregoing initial classification basic (that is the predetermined classification data).

In another embodiment, the step 210 comprises the following flows: classifying each of the items based on the predetermined categories of the items and the properties of the items by the processor 120, such that each of the items comprises a classification category. For example, the processor 120 may use but not limited to a machine learning device to execute step 210, and the machine learning device can be but not limited to Support Vector Machine (SVM). The SVM can further classify the items based on the initial category (that is the predetermined category) of the items for obtaining accurate categories (that is the classification category) which are suitable for each of the items. In one embodiment, if the classification category of one of the items is not suitable for the foregoing item, the inventory management method 200 may let users enter commands for adjusting the classification category of the foregoing item through the human interface 130.

In still another embodiment, the step 210 comprises the following flows: dividing the items into a plurality of training items (i.e., training set) and a plurality of testing items (i.e., testing set) by the processor 120; obtaining a first parameter value based on the training items by the processor 120 so as to establish a machine learning device SVM, and verifying classification accuracy of the machine learning device SVM by using the testing items; classifying the items by the machine learning device SVM if the classification accuracy of the machine learning device SVM is larger than a predetermining threshold. On the other hands, the step 210 comprises the following flows: reclassifying the items into the training items and the testing items by the processor 120 if the classification accuracy of the machine learning device SVM is not larger than the predetermining threshold, and obtaining a second parameter value based on the training items which are reclassified so as to establish the machine learning device SVM, and verifying classification accuracy of the machine learning device by using the testing items; classifying the items by the machine learning device SVM if the classification accuracy of the machine learning device SVM is larger than the predetermining threshold. Besides, if the classification accuracy of the machine learning device SVM is not enough, the step 210 continuously reclassifies the items to obtain parameters for testing until the classification accuracy of the machine learning device SVM is enough for executing the classification of the items.

In yet another embodiment, the step 220 comprises the following flows: providing each of the items a prediction module based on the classification categories of the items and the properties of the items by the processor 120. For example, after the accurate category (that is the classification category) of each of the items is obtained, the processor 120 can determine suitable prediction module based on accurate categories of the items together with the properties of the items stored in the storage 110, such that the accuracy of the inventory predicted results of the items can be enhanced.

Specifically, the processor 120 is performed to obtain the historical selling data of different categories by analyzing the accurate category (that is the classification category) so as to provide the prediction modules which are used by the items, such that the prediction modules may predict predicted demand quantity of the items. In one embodiment, if the prediction module of one of the items is not suitable for the foregoing item, the inventory management method 200 may let users enter commands for adjust the prediction module of the foregoing item through the human interface 130.

In one embodiment, the step 230 comprises the following flows: providing a dynamic inventory-management decision table based on the prediction modules of the items by the processor 120. For example, after the prediction module of each of the items is obtained, the processor 120 may provide the dynamic inventory-management decision table based on the prediction module. From the dynamic inventory-management decision table, users may know suggestion inventory-management quantity of each of the items, and users may adjust inventory management based on the suggestion. Specifically, the processor 120 analyzes difference among the predicted demand quantity of the items and actual demand quantity of the items for providing the foregoing dynamic inventory-management decision table so as to decide the ordered quantity of the items. In one embodiment, the inventory management method 200 may let users to interact with the human interface 130 so as to make sure the ordered quantity of the items in the dynamic inventory-management decision table. If the ordered quantity of one of the items is not suitable for the foregoing item, users may use the human interface 130 to enter commands for adjust the ordered quantity of one of the foregoing items.

In one embodiment, the inventory management method 200 further comprises the step as follows: generating the predetermined classification data based on categories of the items defined by the inventory theory by the processor 120; and defining the prediction modules of the items corresponding to the predetermined classification data based on properties of the items stored in the storage 110 by the processor 120, and the prediction module is then stored in the storage 110. It is noted that the prediction module and data of the items (a plurality of items, the properties of the items, and the predetermined classification data) can be stored in different storages.

In another embodiment, the inventory management method 200 further comprises the following step: calculating the demand quantity of the items based on the classification categories of the items and the prediction modules of the items by the processor 120; providing the dynamic inventory-management decision table based on the demand quantity of the items by the processor 120. From the dynamic inventory-management decision table, users may know suggestion inventory-management quantity of each of the items, and users may adjust inventory management based on the suggestion.

Further, as may be appreciated by persons having ordinary skill in the art, the steps of inventory management method 200 are named according to the function they perform, and such naming is provided to facilitate the understanding of the present disclosure but not to limit the steps. Combining the step into a single step or dividing any one of the steps into multiple steps, or switching any step so as to be a part of another step falls within the scope of the embodiments of the present disclosure.

In view of the above embodiments of the present disclosure, it is apparent that the application of the present invention has the advantages as follows. Embodiments of the present disclosure provide an inventory management system and an inventory management method, which may provide proper inventory prediction modules based on different categories of products, so as to reduce error of the inventory prediction and enhance profits of companies.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An inventory management system, comprising:
a storage is configured to store a plurality of items, properties of the items and predetermined classification data; and
a processor electrically connected to the storage, and configured to execute steps as follows:
(a) classifying each of a plurality of items based on the predetermined classification data, such that each of the items comprises a predetermined category, and classifying each of the items based on the predetermined categories and properties of the items, such that each of the items comprises a classification category;
(b) providing each of the items a prediction module based on the classification categories of the items and the properties of the items; and
(c) providing a dynamic inventory-management decision table based on the prediction modules of the items.

2. The inventory management system of claim 1, wherein the step (a) further comprises:
dividing the items into a plurality of training items and a plurality of testing items;
obtaining a first parameter value based on the training items so as to establish a machine learning device, and verifying classification accuracy of the machine learning device by using the testing items; and
classifying the items by the machine learning device if the classification accuracy of the machine learning device is larger than a predetermining threshold.

3. The inventory management system of claim 2, wherein the step (a) further comprises:
reclassifying the items into the training items and the testing items if the classification accuracy of the machine learning device is not larger than the predetermining threshold;
obtaining a second parameter value by the processor based on the training items which are reclassified so as to establish the machine learning device, and verifying classification accuracy of the machine learning device by using the testing items; and
classifying the items by the machine learning device if the classification accuracy of the machine learning device is larger than the predetermining threshold.

4. The inventory management system of claim 1, wherein the step (b) further comprises:
obtaining properties corresponding to the items by analyzing the classification categories of the items by the processor so as to provide the prediction modules of the items for predicting a predicted demand quantity of the items.

5. The inventory management system of claim 4, wherein the step (c) further comprises:
receiving the predicted demand quantity of the items by the processor, and analyzing difference between the predicted demand quantity of the items and actual demand quantity of the items so as to provide the dynamic inventory-management decision table.

6. The inventory management system of claim 1, further comprising:
a human interface coupled to the storage and the processor, and configured to control the processor based on a command.

7. The inventory management system of claim 6, wherein the human interface is configured to adjust the classification categories of the items, the prediction modules of the items or the dynamic inventory-management decision table generated by the processor based on the command.

8. The inventory management system of claim 1, further comprising:
an item classification database coupled to the processor, and configured to store the classification categories of the items.

9. The inventory management system of claim 8, wherein the step (a) further comprises:
defining categories of the items based on inventory theory by the processor so as to generate the predetermined classification data; and
defining the prediction modules corresponding to the predetermined classification data of the items based on the properties of the items by the processor, and storing the prediction modules in the storage.

10. The inventory management system of claim 9, further comprising:
calculating demand quantity of the items based on the classification categories of the items and the prediction module by the processor; and
providing the dynamic inventory-management decision table based on the demand quantity of the items by the processor.

11. An inventory management method, comprising:
(a) classifying each of a plurality of items based on predetermined classification data by a processor, such that each of the items comprises a predetermined category, and classifying each of the items based on the predetermined categories and properties of the items by the processor, such that each of the items comprises a classification category;
(b) providing each of the items a prediction module based on the classification categories of the items and the properties of the items by the processor; and
(c) providing a dynamic inventory-management decision table based on the prediction modules of the items by the processor.

12. The inventory management method of claim 11, wherein the step (a) further comprises:
dividing the items into a plurality of training items and a plurality of testing items by the processor;
obtaining a first parameter value based on the training items by the processor so as to establish a machine learning device, and verifying classification accuracy of the machine learning device by using the testing items; and
classifying the items by the machine learning device if the classification accuracy of the machine learning device is larger than a predetermining threshold.

13. The inventory management method of claim 12, wherein the step (a) further comprises:
reclassifying the items into the training items and the testing items if the classification accuracy of the machine learning device is not larger than the predetermining threshold;
obtaining a second parameter value by the processor based on the training items which are reclassified so as to establish the machine learning device, and verifying classification accuracy of the machine learning device by using the testing items; and
classifying the items by the machine learning device if the classification accuracy of the machine learning device is larger than the predetermining threshold.

14. The inventory management method of claim 11, wherein the step (b) further comprises:
obtaining properties corresponding to the items by analyzing the classification categories of the items by the processor so as to provide the prediction modules of the items for predicting a predicted demand quantity of the items.

15. The inventory management method of claim 14, wherein the step (c) further comprises:
receiving the predicted demand quantity of the items by the processor, and analyzing difference between the predicted demand quantity of the items and actual demand quantity of the items so as to provide the dynamic inventory-management decision table.

16. The inventory management method of claim 11, further comprising:
controlling the processor based on a command by a human interface.

17. The inventory management method of claim 16, wherein controlling the processor based on the command by the human interface comprises:
adjusting the classification categories of the items, the prediction modules of the items or the dynamic inventory-management decision table generated by the processor based on the command by the human interface.

18. The inventory management method of claim 11, further comprising:
storing the classification categories of the items by an item classification database.

19. The inventory management method of claim 18, wherein the step (a) further comprises:
defining categories of the items based on inventory theory by the processor so as to generate the predetermined classification data; and
defining the prediction modules corresponding to the predetermined classification data of the items based on the properties of the items by the processor, and storing the prediction modules in the storage.

20. The inventory management method of claim 19, further comprising:
calculating demand quantity of the items based on the classification categories of the items and the prediction module by the processor; and
providing the dynamic inventory-management decision table based on the demand quantity of the items by the processor.
